(19) United States
(12) Patent Application Publication
(10) Pub. No.: US 2011/0274532 A1
(43) Pub. Date: Nov. 10, 2011

(54) AUXILIARY DEVICE, ARRANGEMENT AND METHOD IN CARGO HANDLING

(75) Inventors: Atso Poutanen, Naarajarvi (FI); Kari Kakkonen, Naarajarvi (FI)

(73) Assignee: ACTIW OY, Naarajarvi (FI)

(21) Appl. No.: 13/141,729

(22) PCT Filed: Jan. 22, 2010
(86) PCT No.: PCT/FI10/50034

§ 371 Date: Jun. 23, 2011

(30) Foreign Application Priority Data
Jan. 27, 2009 (FI) 20095069

(51) Int. Cl. B65D 90/18; B23P 11/00; B60B 33/00

(52) U.S. Cl. 414/800; 16/42 R; 29/428

(57) ABSTRACT

The invention relates to an auxiliary device in cargo handling. The auxiliary device is a strip, which is arranged on a base under a load. In the strip there are protrusions extending in one direction, in order both to separate the load from the base and to increase friction between the base and the load, in order to move the load by pulling on the strips. The invention also relates to an arrangement and a method in cargo handling.

The present invention relates to an auxiliary device in cargo handling, which auxiliary device is a strip, which is arranged on a base under a load. The invention also relates to an arrangement and method in cargo handling.

A load can be made in a cargo space, such as a container, in different ways. Traditionally, for example, piece goods set on load pallets are moved into the cargo space using pallet-transfer trucks or fork-lift trucks. Automatic loaders also exist, by means of which an entire load can be moved into a cargo space at one time. The removal of the load is, however, a problem. It has been proposed to place cardboard strips between the load and the cargo space, so that the load can be unloaded by pulling on the load and the strips. It is difficult to place the strips under the load and they are insufficiently durable. In addition, strips are only suitable for certain types of product and base. In practice, strips require even and smooth bases, leading to additional costs. Strips also have a tendency to slide from under the load, which can prevent the load from being unloaded as planned.

The present invention is intended to create a new type of auxiliary device for cargo handling, which is durable and suitable for use with different kinds of goods and cargo spaces. In addition, the invention is intended to create a new type of arrangement and method in cargo handling, by means of which a load can be unloaded not only more easily and quickly than previously, but also more cheaply and certainly. The characteristic features of the auxiliary device according to the invention are stated in the accompanying Claim 1. Correspondingly, the characteristic features of the arrangement according to the invention are stated in the accompanying Claim 11. In addition, the characteristic features of the method according to the invention are stated in the accompanying Claim 18. Thanks to its simple, but surprising construction, the auxiliary device according to the invention can be used to create several new properties, which can be utilized particularly when unloading a load. Besides accelerating unloading, forming a load is also simpler than previously. At the same time, damage to the load and the cargo space is also avoided. Even heavy loads can be moved into the transportation means with, however, no reduction in payload, by using several auxiliary devices simultaneously. Besides the simple auxiliary device, other simple devices can also be used in the method. Thus, a load can be unloaded nearly anywhere. Unloading is also quick and sure, thus avoiding unnecessary delays and waits. The auxiliary device is suitable for different kinds of goods and cargo spaces. In addition, loading and unloading can be at least partly automated.

In the following, the invention is described in detail with reference to the accompanying drawings, depicting some applications of the invention, in which

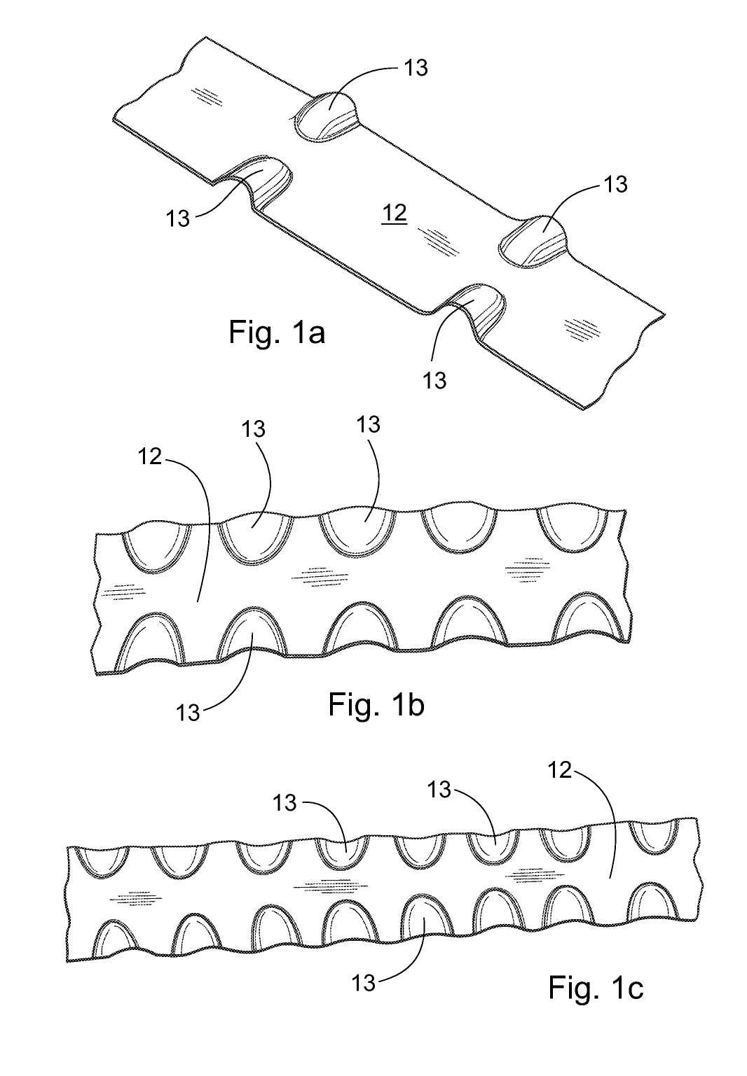

FIG. 1a shows part of the auxiliary device according to the invention,

FIG. 1b shows a view of the upper surface of the auxiliary device according to the invention,

FIG. 1c shows a view of the under surface of the auxiliary device of FIG. 1b,

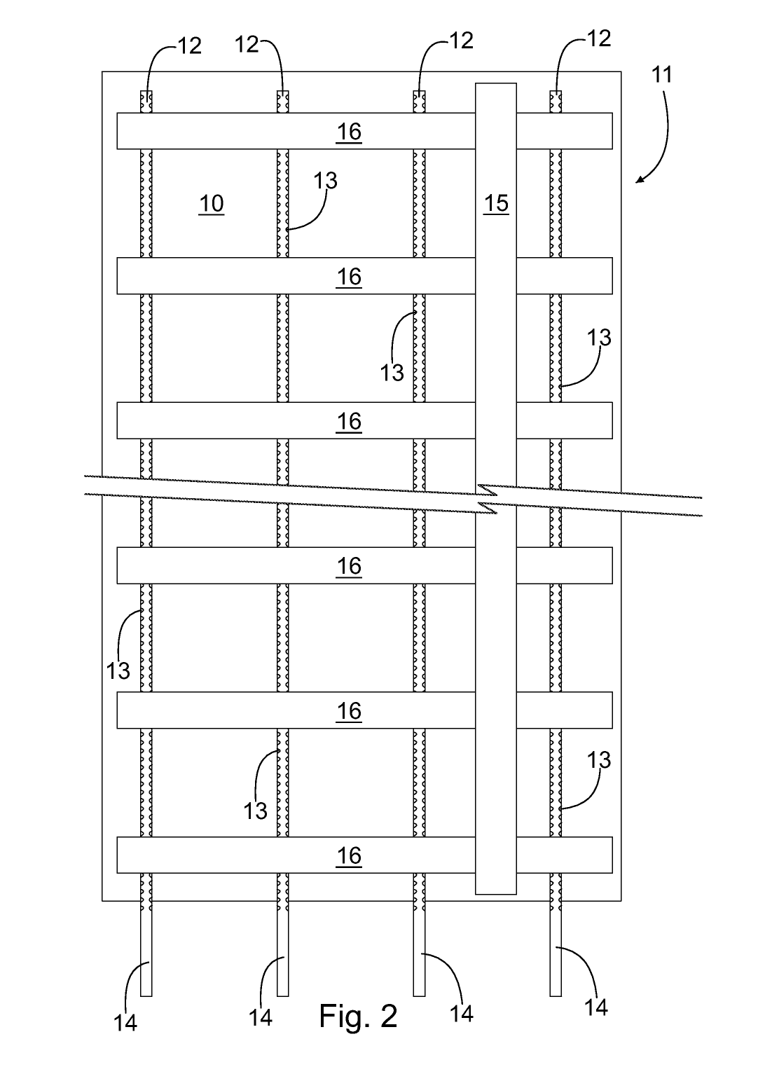

FIG. 2 shows a schematic drawing of the arrangement according to the invention,

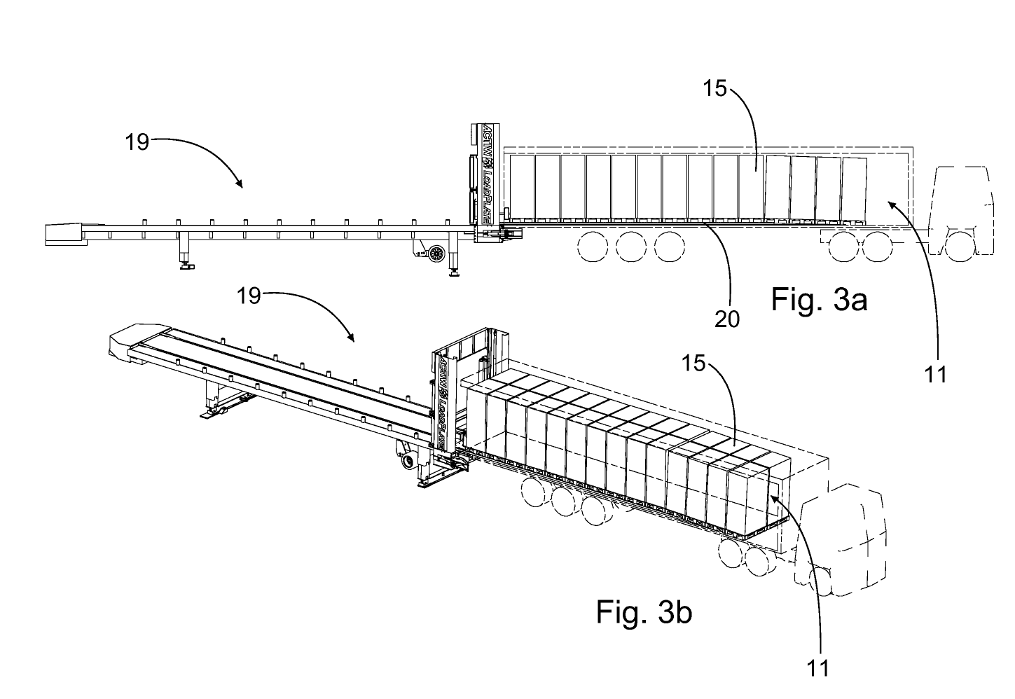

FIG. 3a shows a side view of the apparatus used in cargo handling,

FIG. 3b shows the apparatus of FIG. 3a, seen at an angle from in front,

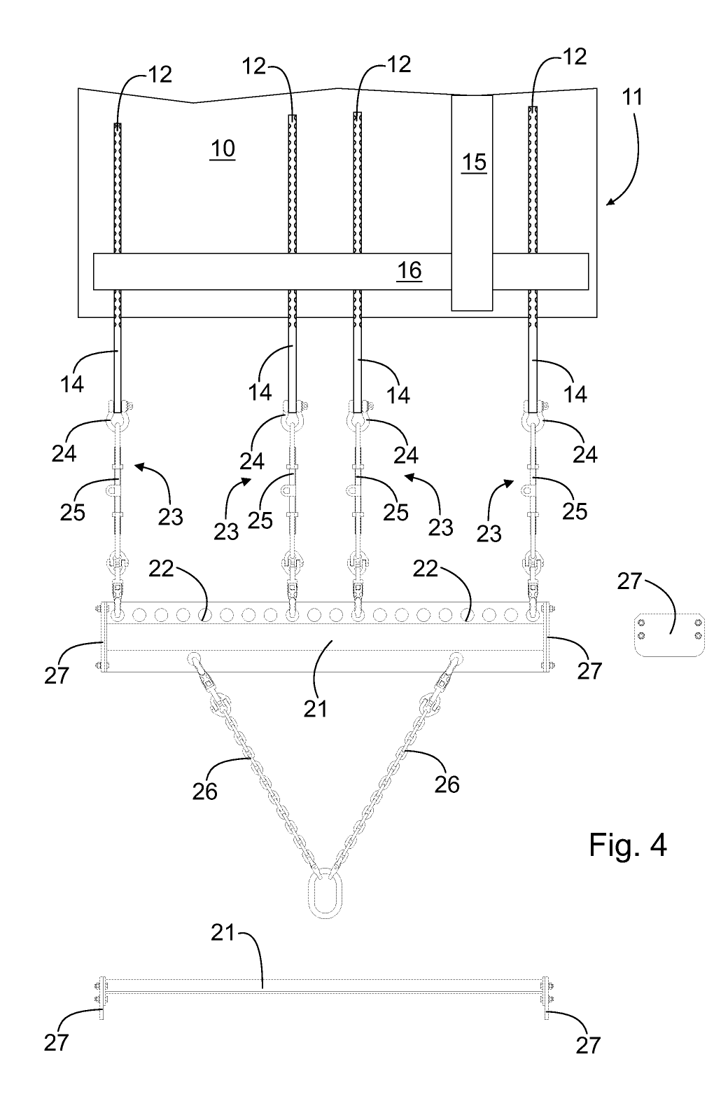

FIG. 4 shows the stage of the method according to the invention, in which the load is pulled out of the cargo space,

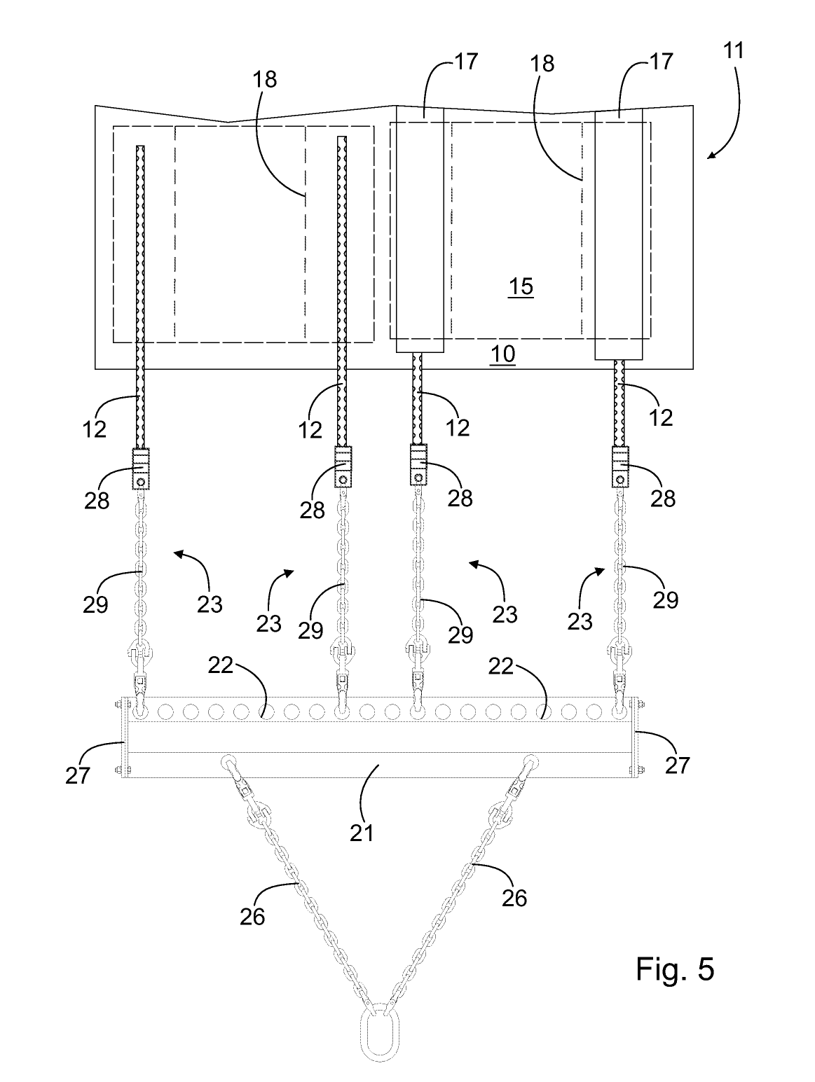

FIG. 5 shows a second adaptation of the stage according to FIG. 4, and

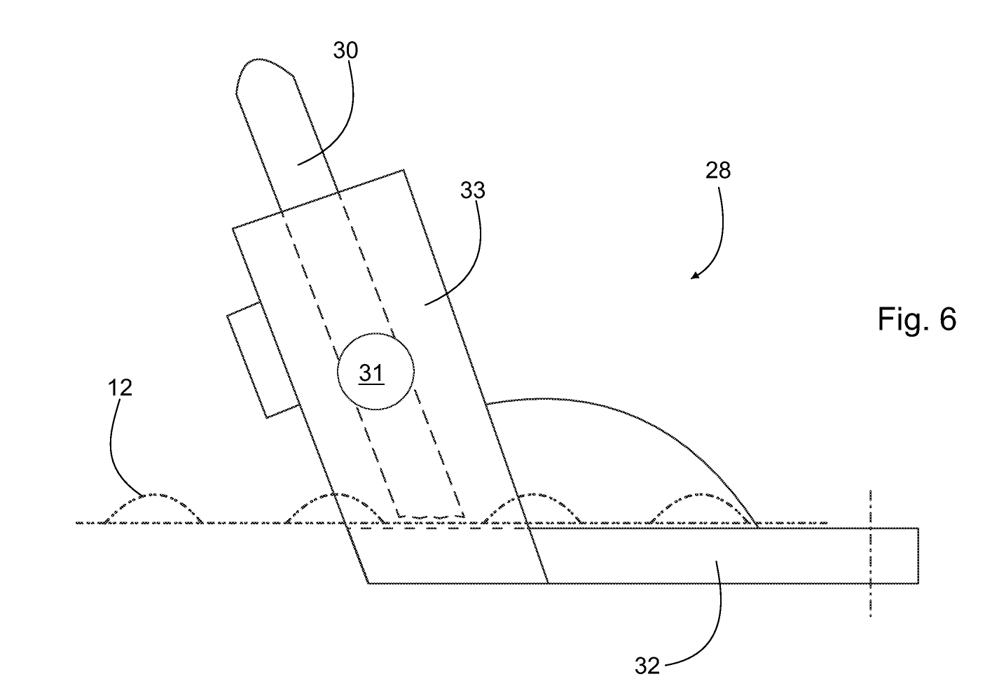

FIG. 6 shows a side view of the connector device according to the invention.

FIGS. 1a-c shows part of the auxiliary device according to the invention, which can be utilized in cargo handling. In cargo handling, a load 11 is arranged on a base 10 (FIG. 2). According to the invention, the auxiliary device is a strip 12, in which there are protrusions 13 extending in one direction. In other words, all the protrusions are formed on one surface of the strip. The protrusions have two important tasks. Firstly, the protrusions lift the load 11 off the base 10. Thus, the load can be moved, despite irregularities in the base. Secondly, the strip 12 increases the friction between the base 10 and the load 11. The increased friction can be exploited in loading and unloading. The strips are particularly intended for moving the load 11 by pulling the strips 12.

A crucial feature is that the protrusions extend to only one side, so that the surface of the strip lying against the base is essentially even and smooth. Thus, damage to the base is avoided while the friction between the base and the strip remains sufficiently low. The friction is, however, high enough for the load to remain in place, even without being secured. However, the load must generally be secured in any case, simply to conform to road traffic legislation. The protrusions 13 are preferably arranged in the basic material of the strip 12. In other words, the protrusions are formed from the basic material. Thus, the protrusions will be sure to remain attached. A good material for a strip is a metal band, for example, a packaging band or a hoisting band, which has good tensile strength and corrosion resistance. By using a packaging or hoisting band it is possible to manage by using even very thin material thicknesses. According to the invention, the thickness of the strip 12 is 0.5-2 mm, preferably 0.7-1.2 mm. A thin strip can be stored and transported when rolled up while the protrusions can be easily formed as cup-shaped raised bosses in the basic material, for example, by shaping. Deviating from the description, the shape and/or location of the protrusions can be varied in different applications.

Despite the thin basic material, particularly embossing can be used to make the height of the protrusion 13 4-12 mm, preferably 5-7 mm. In other words, embossing can be used to increase by many times the functional thickness of the basic material. Such a dimension will be sufficient to separate the load sufficiently from the base. In addition to a thin strip, it is possible to use a narrow strip, mainly due to the strength properties of a packaging band. According to the invention, the strip 12 is 20-40-mm, preferably 25-35-mm wide. Little material will then be used. FIGS. 1a and 1b show the upper surface of the strip while FIG. 1c shows the under surface. In practice, the strip has even edges, despite the embossing. However, in FIGS. 1b and 1c, the edges appear to undulate slightly, as the strip is shown rolled up. In the longitudinal direction of the strip 12, the protrusions 13 are preferably at intervals of 10-150 mm, most preferably of 20-70 mm. Thus, several protrusions are directed onto the load, which ensures sufficient friction. However, in this embodiment, part of the strip 12 is even, a loop 14 being arranged in this part (FIG. 2). Load straps, for example, by means of which the load can be moved by pulling on the strips, can be threaded into the loops. By means of a suitable arrangement, the loop can also be formed in an embossed part of the band. Many different kinds of locks and similar are possible when forming the loop. Two alternative forms of traction are shown hereinafter, in connection with FIGS. 4 and 5.

When using four or five strips, for example, it is already possible to move significant loads. In practice, a load of steel bars, for example, can weigh more than thirty tonnes. A normal load in a container is from ten to thirty tonnes. As materials are developed, it may also be possible to manufacture the strip from plastic. The use of various composite materials can also be envisaged. However, the important factor is to achieve a sufficient separating effect with a small material thickness. The goal is reached by using the bosses according to the invention, by means of which a functioning auxiliary device can be made from even a thin strip.

As such, basic packaging band is a recyclable material. However, the formation of the bosses forms its own work stage, making it preferable to return the strips to the loader. Even more preferable is to use the strips to load a new load and to transport the strips under the load. A returnable strip can be manufactured from a relatively thick material, which will withstand even large loads. In order to keep costs reasonable, a disposable strip would probably have to be made from a considerably thinner material, while the dimensioning and number of the strips would have to be optimized in other ways too.

FIG. 2 shows schematically the arrangement according to the invention in cargo handling, in which a load 11 is arranged on a base 10. Generally, the load consists of piece goods of different types and shapes. In this case, the load is formed of long goods 15, of which only one is shown. Long goods are, for example, raw-steel bars or sawn goods, the transportation of which previously required a special container, with a roof or at least one side wall that could be opened during loading. Transverse wooden battens 16; into which the protrusions 13 bite, are preferably used with, long goods. Load pallets can also be used. Longitudinal battens 17 can then be used instead of transverse battens under each strip, in which case nearly all the protrusions will coincide with the timber (FIG. 5, right-hand side). Load pallets 18 can also be placed on top of the strips 12, without transverse or longitudinal battens (FIG. 5, left-hand side). Other materials can also be used instead of timber, provided the friction remains sufficient. The load is sought to be made in such a way that the greatest loading occurs at the strips. In other words, the weight distribution of the load is taken into account when placing the strips. This, for its part, prevents the strips from unintentionally slipping from under the load.

According to the invention, between the load 11 and the base 10 there are thus several strips 12, in which there are protrusions 13 extending in the direction of the load 11, both to separate the load 11 from the base and to increase the friction between the base 10 and the load 11, in order to allow the load 11 to be moved by pulling on the strips 12. The base 10 of FIG. 2 can be a pallet or the bottom of a container. On the other hand, it can also be a transfer plate, on which the load, together with the strips, is pushed into a container during loading. Once the load is in the container, the transfer plate is pulled out. In order to prevent the strips from slipping and to distribute the load evenly among the strips, the free ends of the strips can be wound around the last transverse batten, prior to loading. FIGS. 3a and 3b show an apparatus 19 for operating a transfer plate. In this case, the transfer plate 20 is already in the cargo space, under the load 11.

In the method, a load 11 is arranged on a base 10 in cargo handling. According to the invention, several strips 12 are arranged between the load 11 and the base 10, in which strips 12 there are protrusions 13 extending in the direction of the load 11, both to separate the load 11 from the base and to increase the friction between the base 10 and the load 11. In addition, the load 11 is moved by pulling on the strips 12. Thanks to the auxiliary device, an enclosed container or some other cargo space can be used to transport the load, because unloading can be carried out using simple means, by pulling on the strips. In tests, loads of more than twenty tonnes have been successfully pulled out of a container over four thin and narrow strips, onto bases of different materials. A smooth strips will slide over both a metal and a concrete surface. In measurements, the traction required was first of all about seven tonnes when pulling started, dropping to less than five tonnes. Thus, the static coefficient of friction was about 0.3. The number of strips could even be reduced, or thinner strips could be used, because a single strip, or more precisely loop, withstands traction of four tonnes. The container must be secured during pulling, to prevent it moving.

Simply pulling on the loops by using load straps may cause the mutual positioning of the strips to change detrimentally. Thus a traction bar, for example, in which there are attachments for each loop, can be threaded through the loops. One traction bar 21 is shown in FIG. 4. Generally, the arrangement according to the invention includes a traction bar, in which there are several attachment points for attachments, of which there is one at the position of each strip. In this case, there are traction holes 22 at regular intervals along the traction boom 21, to which the necessary number of attachments 23 can be secured. The attachment will then be as close as possible to the position of the strip. In the attachment 23 shown, there is a shackle 24, to which the loop 14 is attached. In the attachment 23 there is also a turnbuckle 25, allowing the length of the attachment to be adjusted precisely. The traction bar 21 is attached to a work machine, for example a forklift truck, by means of a chain 26. In the application shown, there are a kind of skid 27 at the ends of the traction bar 21, thus avoiding the traction bar catching on possible unevennesses in the base.

However, there are drawbacks in the traction bar described above, which may slow unloading and even prevent unloading entirely. During loading, errors may occur in the positioning of the strips, as a result of which the loops remain at different locations longitudinally. This is a major problem, particularly when using load straps for pulling. The adjustments of the traction bar may also be insufficient, so that especially in the starting stage of pulling the traction may be concentrated in even only one strip. The strip in question will then be overloaded. As a result, the strip may slip, damaging the transverse battens and possibly leading to a loss of adhesion, in which case the other strips may become overloaded. On the other hand, the overloaded strip may even break. The problems arising from variations in length can, however, be avoided by using an attachment device 28 according to the invention, which is arranged to grip the strip directly (FIG. 5). This will completely avoid having to make loops. At the same time, length adjustment is make by altering the location of the attachment device, so that the differences in length in the strips can be compensated. In practice, this also permits the strips to be placed approximately when making the load. The turnbuckles can also be replaced with simple chains 29, preferably with rigid chains, which will further simplify the construction of the traction bar and facilitate its use. FIG. 5 also shows the longitudinal battens 17 and a load pallet 18 arranged on top of the strips 12.

FIG. 6 shows one attachment device 28 according to the invention. An important feature is a self-locking tongue 30, which is thin enough to fit in between the protrusions. According to the invention, there are protrusions along the entire length of the strip. Stated in more general terms, the attachment includes a self-locking attachment device, which is arranged to lock between the protrusions. A strip 12 can be simply threaded into the attachment device 28, when the tongue 30 turns around the pivot pin 31, in this case counterclockwise. If necessary, the tongue can be released manually by rotating it, particularly if the tongue is spring-loaded. The loading spring lies around the pivot pin and is arranged to rotate the tongue to the closed position, i.e. in this case clockwise (not shown). The attachment device is pushed as far as possible. If the tongue remains to rotate on top of the protrusions, the attachment device is moved backwards slightly, when the tongue will rotate and press on a flat part of the strip. When the load is pulled, the tongue grips increasingly tightly on the strip. In other words, the strip 12 is compressed between the tongue 30 and the body plate 32 of the attachment device 28. Support plates 33 are fitted to the body plate 32, between which the tongue 30 is pivoted. After pulling, the attachment device is detached by releasing the tongue and removing the strip from the attachment device. In FIG. 6, the strip 12 is shown by a double-dotted broken line. The point of attachment of the chain is shown by the dotted broken line.

The attaching and detaching of the attachment device is rapid and simple. In addition, using it achieves a short interval, which creates a precise adjustment for the location of the attachment device. In practice, the interval is only a few tens of millimetres. In addition, making loops at the ends of the strips is avoided. The auxiliary device according to the invention is simple, but versatile. The auxiliary device is suitable for handling nearly all kinds of goods. Correspondingly, the use of the arrangement and method achieves significant savings in logistics. In addition, unloading is sure while in loading the strips can be placed freely and even approximately. Unloading will succeed using even a simple work machine and the strips can be reused several times.

1-19. (canceled)

20. Auxiliary device in cargo handling, which auxiliary device is a strip, which is arranged on a base under a load in order to separate the load from the base, and which has one even and smooth surface in order to move the load by pulling on the strips, characterized in that in the strip there are protrusions extending in one direction in relation to the plane of the strip in order to increase friction between the strip and the load, and the protrusions are arranged in the basic material of the strip, and each protrusion is shaped as a cup-like boss.

21. Auxiliary device according to claim 20, characterized in that the strip is a metal band, such as a packaging band, a hoisting band, or similar.

22. Auxiliary device according to claim 20, characterized in that the thickness of the strip is 0.5-2 mm.

23. Auxiliary device according to claim 20, characterized in that the height of the protrusions is 4-12 mm.

24. Auxiliary device according to claim 20, characterized in that the width of the strip is 20-40 mm.

25. Auxiliary device according to claim 20, characterized in that, in the longitudinal direction of the strip, the protrusions are at 10-150-mm.

26. Auxiliary device according to claim 20, characterized in that part of the strip is flat, in which part a loop is arranged.

27. Auxiliary device according to claim 20, characterized in that there are protrusions over the entire length of the strip.

28. Arrangement in cargo handling, in which a load is arranged on a base, and in which there are several strips between the load and the base in order to separate the load from the base, and each strip has one even and smooth surface against the base in order to move the load by pulling on the strips, characterized in that in the strips there are protrusions extending in the direction of the load in order to increase friction between the strip and the load, and the protrusions are arranged in the basic material of the strip, and each protrusion is shaped as a cup-like boss.

29. Arrangement according to claim 28, characterized in that the strip is a metal band having a thickness of 0.5-2 mm and the height of the protrusions is 4-12 mm.

30. Arrangement according to claim 28, characterized in that the load includes piece goods of different kinds and shapes.

31. Arrangement according to claim 28, characterized in that longitudinal timber battens or transverse timber battens, on top of which the load is formed, are arranged on top of the strips.

32. Arrangement according to claim 28, characterized in that the load is arranged on load pallets, which are placed on top of the strips.

33. Arrangement according to claim 28, characterized in that the arrangement includes a traction boom, in which there are several attachment points for attachments, of which there is one at the position of each strip.

34. Arrangement according to claim 33, characterized in that the attachment includes a self-locking attachment device, which is arranged to lock on the strip between the protrusions.

35. Method in cargo handling, in which a load is arranged on a base, in such a way that several strips are arranged between the load and the base in order to separate the load from the base, and each strip has one even and smooth surface against the base making possible that the load is moved by pulling on strips, characterized in that strips are used, in which there are protrusions extending in the direction of the load in order to increase friction between the strip and the load, and the protrusions are arranged in the basic material of the strip, and each protrusion is shaped as a cup-like boss.

36. Method according to claim 35, characterized in that in the method a strip is a metal band having a thickness of 0.5-2 mm and the height of the protrusions is 4-12 mm.

37. Method according to claim 35, characterized in that in the method an arrangement including a traction boom, in which there are several attachment points for attachments that include a self-locking attachment device, which is arranged to lock on the strip between the protrusions, of which there is one at the position of each strip, is used.

38. Method according to claim 35, characterized in that, in the method, a transfer plate is used, on which the load together with the strips is formed, and using which the load is moved into the cargo space.
